(19) United States
(12) Patent Application Publication
(10) Pub. No.: US 2025/0102293 A1
(43) Pub. Date: Mar. 27, 2025

(54) 3D DEPTH-SENSING DEVICE AND ILLUMINATION MODULE THEREFOR

(71) Applicant: GOERTEK ELECTRONICS INC., SANTA CLARA, CA (US)

(72) Inventors: TAKEO MATSUKAWA, SAN JOSE, CA (US); KUN GAO, DUBLIN, CA (US)

(73) Assignee: GOERTEK ELECTRONICS INC., SANTA CLARA, CA (US)

(21) Appl. No.: 18/634,239

(22) Filed: Apr. 12, 2024

Related U.S. Application Data
(60) Provisional application No. 63/540,222, filed on Sep. 25, 2023.

(51) Int. Cl. G01B 11/22

(52) U.S. Cl. CPC G01B 11/22

(57) ABSTRACT

Herein disclosed is a three-dimensional depth-sensing device and an illumination module for the same. The illumination module for a three-dimensional depth-sensing device comprises: a light source; a diffuser, diffusing light from the light source; a tunable lens, positioned after the diffuser and having at least three statuses; and a control unit, setting the tunable lens to one of the at least three statuses. The at least three statuses of the tunable lens correspond to at least three configurations between a dot light and a flood light.

### CROSS-REFERENCE TO RELATED APPLICATIONS

The present disclosure is a Non-Provisional application which claims priority of US. Provisional Application No. 63/540,222, filed on Sep. 25, 2023, the entirety of which is incorporated herein by reference.

### FIELD OF THE INVENTION

This disclosure relates to the field of three-dimensional sensing, and more specifically, to an illumination module for a three-dimensional depth-sensing device and the three-dimensional depth-sensing device itself.

### BACKGROUND OF THE INVENTION

A three-dimensional (3D) sensing device or depth-sensing device is utilized to detect the three-dimensional structure of an object, including depth information. A depth-sensing device, such as a Time-of-Flight (ToF) sensor, typically comprises a TX (transmitter)/illumination module and an RX (receiver)/sensor module. It usually employs a fixed illumination module using VCSEL (Vertical-Cavity Surface-Emitting Laser), LED (Light Emitting Diode), or laser technology. In most cases, the fixed illumination module generates either flood or dot illumination.

Since the 3D sensing device has a fixed illumination, its usage/application will be limited, and it is difficult to cover wider use scenarios. For example, a dot illumination is good for longer distance object sensing while a flood illumination is good for a shorter distance object sensing.

There is a solution that uses LC lens to switch between flood and dot. However, this method takes larger switching time and it tends to have only two states of switching state which is on or off.

FIG. 1 is a schematic diagram showing the structure of a 3D sensing device. The 3D sensing device in FIG. 1 includes a controller 1, an imaging element 2, an imaging lens unit 3 and an illumination module 4. The arrow lines 5, 6 indicate the phase compensation from the controller 1 to the imaging element 2 and an illumination module 4. The light from the illumination module 4 irradiates an object 7 and the light reflected by the object 7 is received through the imaging lens unit 3 by the imagining element 2. The controller 1 processes the data from the imaging element 2 and generates a 3D image.

FIG. 2 shows a structure of a 3D sensing device. As shown in FIG. 2, the 3D device includes an illumination module (Tx) 24 and an imaging module 25. The illumination module 24 includes a light source 22 such as VCSEL and a diffuser 21. The light source 22 may also include a driver. The diffuser 21 diffuses the light from the light source 22 to form a flood light or a dot light. Normally, the diffuser 21 can only be controlled with on or off status, and thus the illumination module 24 can only provide at most two kinds of lights, such as flood light and dot light, as shown on the left of FIG. 2.

### SUMMARY OF THE INVENTION

One objective of this invention is to provide a new technical solution for an illumination module of a three-dimensional depth-sensing device.

According to a first aspect of the disclosure, there is provided an illumination module for a three-dimensional depth-sensing device, comprising: a light source; a diffuser, which diffuses light from the light source; a tunable lens, positioned after the diffuser and having at least three statuses; and a control unit, which sets the tunable lens to one of the at least three statuses, wherein the at least three statuses of the tunable lens correspond to at least three configurations between a dot light and a flood light.

According to a second aspect of the disclosure, there is provided a three-dimensional depth-sensing device, comprising: an illumination module according to an embodiment; and an imaging module, which senses three-dimensional depth information by obtaining light coming from the illumination module and reflected or diffused by an object. According to an embodiment of this invention, the disclosure can provide a new structure of illumination module to provide more flood-dot ratios for the illumination.

Further features of the disclosure and advantages thereof will become apparent from the following detailed description of exemplary embodiments according to the disclosure with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIG. 1 is a schematic diagram showing the structure of a 3D sensing device.

FIG. 2 shows a structure of a 3D sensing device.

FIG. 3 shows a structure of a 3D sensing device according to an embodiment.

FIG. 4 illustratively shows an illumination effect of a 3D sensing device.

FIG. 5 schematically shows a block diagram of an illumination module according to an embodiment.

FIG. 6 schematically shows lights that can be provided by an illumination module according to an embodiment.

FIG. 7 schematically shows a block diagram of an illumination module according to another embodiment.

FIG. 8 schematically shows lights that can be provided by an illumination module according to another embodiment.

FIG. 9 schematically shows a block diagram of an illumination module according to still another embodiment.

FIG. 10 schematically shows lights that can be provided by an illumination module according to still another embodiment.

FIG. 11 schematically shows a block diagram of an illumination module according to further another embodiment.

FIG. 12 schematically shows lights that can be provided by an illumination module according to further another embodiment.

### DETAILED DESCRIPTION OF THE EMBODIMENTS

Various exemplary embodiments of the disclosure will now be described in detail with reference to the drawings. It should be noted that the relative arrangement of the components and steps, the numerical expressions, and numerical values set forth in these embodiments do not limit the scope of the disclosure unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

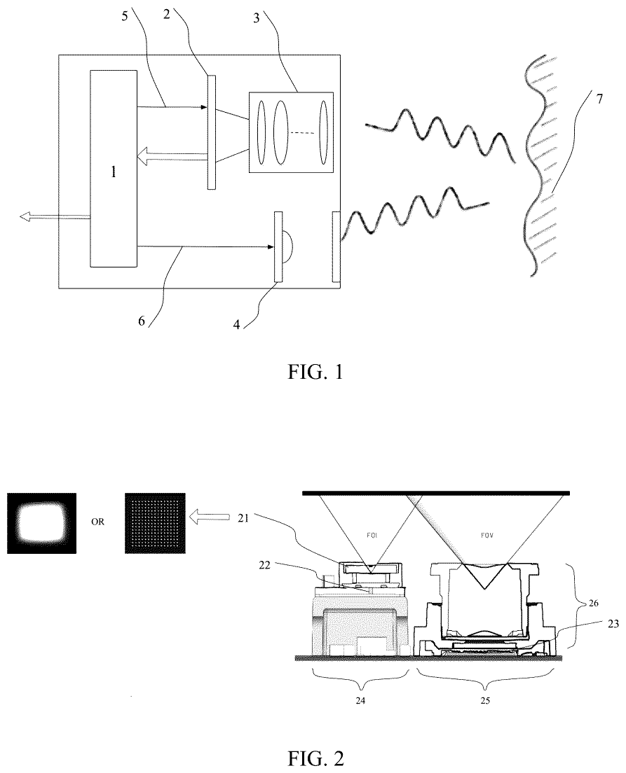

In variable embodiments, a 3D depth-sensing device uses variable dot-flood illumination with integrated electrically tunable lens. Compared with the 3d sensing device shown in FIG. 1 or FIG. 2, the proposed 3D sensing device could provide illumination with more than two flood-dot ratio options.

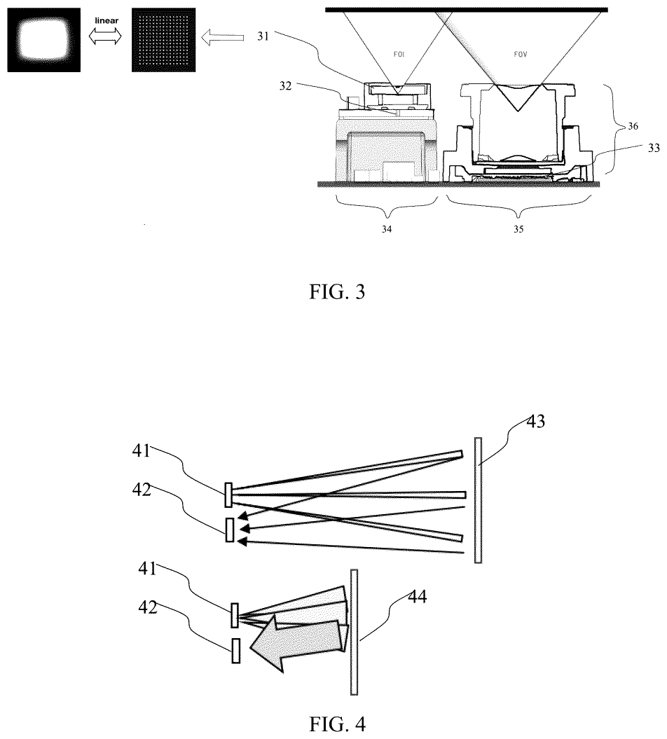

FIG. 3 shows a structure of a 3D sensing device according to an embodiment. As shown in FIG. 3, the 3D sensing device includes an illumination module (Tx) 34 and an imaging module 35. The illumination module 34 includes a light source 32 such as VCSEL and a diffuser 31. The light source 32 may also include a driver. The diffuser 31 diffuses the light from the light source 32 to form a flood light or a dot light. The diffuser 31 includes an electrically tunable lens and thus it can provide more flood-dot ratio options, as shown on the left of FIG. 3.

FIG. 4 illustratively shows an illumination effect of a 3D sensing device. As shown in the upper portion of FIG. 4, in a first scenario, the illumination module 41 irradiates light with smaller flood-dot ratio (more like dot light) onto an object 43 at a faraway position and the imaging module 42 receives the reflected light and generates 3D images. As shown in the lower portion of FIG. 4, in a second scenario, the illumination module 41 irradiates light with smaller flood-dot ratio (more like dot light) onto an object 44 at a near position and the imaging module 42 receives the reflected light and generates 3D images.

In an embodiment, the illumination module (Tx) 34 is controlled to generate a TX illumination between flood and dot by integrating a tunable lens to the illumination module and by controlling the tunable lens electrically. In an example, the tunable lens has a small aperture and high tuning speed. The tunable lens can be continually tuned within a tunable range. This will enable smaller form factor, low latency, and relatively linear dot to flood ratio depending on the use scenarios. Nowadays, many smartphones utilize tunable lenses for the auto-focus function, where the size, speed, and tunability have become more refined. Such tunable lenses can also serve as diffusers in the illumination module, which could further reduce the manufacturing costs and enhance the stability of the products due to the maturity of these lenses.

By using such a diffuser with electrically tunable lenses, a single 3D sensing device can achieve variable dot-food ratios, which will let the sensing system of the 3D sensing device more adaptive. A user does not need to bring several devices to different scenarios. Based on the current illumination ratio and the depth information, the flood-dot ratio can be optimized to get a better information around the region of illumination, especially in indirect ToF system. CMOS based image sensor with larger pixel numbers can detect more depth information when the dot size is increased. This 3D sensing device can also be provided with a feedback system to dynamically adjust the dot-flood ratio to automatically/semi-automatically control the sensing system therein to obtain better information from the device.

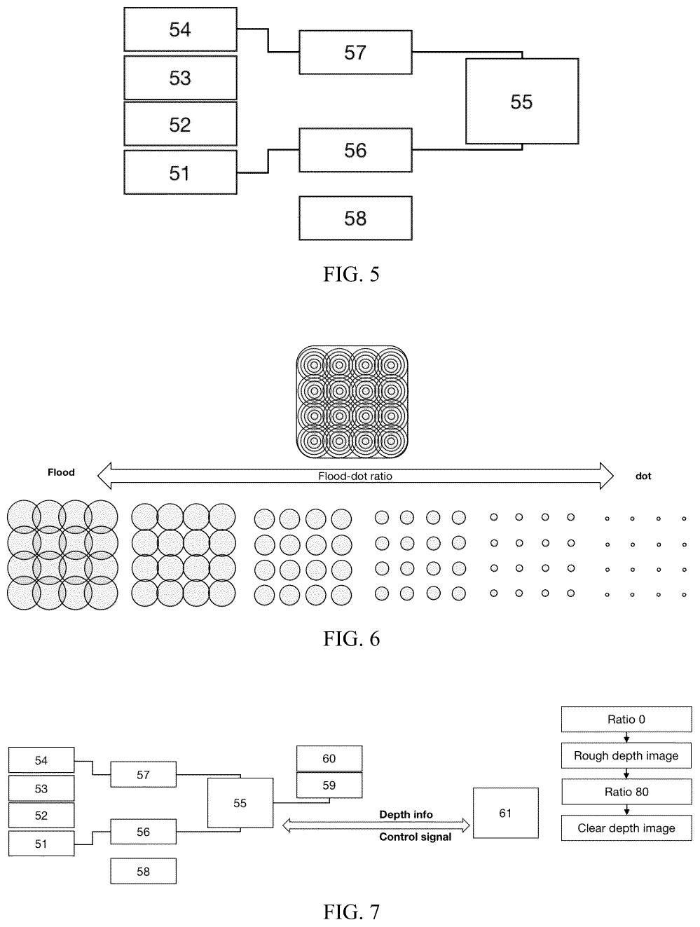

FIG. 5 schematically shows a block diagram of an illumination module according to an embodiment. As shown in FIG. 5, the illumination module for a three-dimensional depth-sensing device comprises: a light source 51; a diffuser 53, which diffuses light from the light source; a tunable lens 54, positioned after the diffuser 53 and having at least three statuses; and a control unit 55, which sets the tunable lens to one of the at least three statuses. The at least three statuses of the tunable lens correspond to at least three configurations between a dot light and a flood light. Unlike the illumination module shown in FIGS. 1 and 2, the illumination module shown in FIG. 5 can generate an illumination light with more flood-dot ratio options, which will provide more freedom of design and also will improve the user experience.

For example, the light source 51 can VCSEL/Laser/LED light source. The diffuser 53 can be DOE (Diffractive Optical Element)/MLA (Micro Lens Array). The tunable lens 54 can change the focus. For example, the tunable lens 54 changes the focus using actuators.

The illumination module may further include a first driver 56 and a second driver 57 to drive the light source 51 and the diffuser 54, respectively based on the commands from the control unit 55. The illumination module may also include a power circuit 57.

In an example, when the tunable lens is in null point, the control unit 55 generates a dot signal based on the diffuser characteristics. When the dot signal is sent from the control unit 55 to the driver 57, an actuator inherent to the tunable lens 54 is excited to adjust the focus of the tunable lens 54.

Alternatively, the illumination module can further comprise a lens unit 52, which is placed between the light source 51 and the diffuser 53. The lens unit 52 can be used to collimates the light from the light source 51.

In an embodiment, the tunable lens 54 includes an electronically tunable liquid crystal lens, which is electrically controllable by applying a voltage. The electronically tunable liquid crystal lens will not undergo physical deformation during the adjustment of the flood-dot ratio. This will reduce the impact of the tunable lens on the illumination module during adjustment.

In another embodiment, the tunable lens 54 includes a polymer lens with the electrically controllable actuator. The electrically controllable actuator can change the polymer lens to one of the at least three statuses. In an example, the electrically controllable actuator includes a voice coil or a piezo unit. This is a matured tunable lens option for the illumination module and will be cost effective.

In an embodiment, the control unit 55 sets the tunable lens to one of the at least three statuses based on at least one of a current illumination ratio and a depth information. So, the illumination for the sensing device will be adapted to the actual usage scenario.

FIG. 6 schematically shows lights that can be provided by an illumination module according to an embodiment. As shown in FIG. 6, the illumination module can provide light with different flood-dot ratios. From the left to the right of FIG. 6, the light changes from flood light to dot light.

FIG. 7 schematically shows a block diagram of an illumination module according to another embodiment. In FIG. 7, the illumination module for a three-dimensional depth-sensing device comprises: a light source 51, a diffuser 53, a tunable lens 54, a lens unit 52, a first driver 56 and a second driver 57 and a power circuit 58, as explained in FIG. 5. In the solution of FIG. 7, the control unit 55 sets the tunable lens to one of at least three statuses based on a manual input from a user.

For example, the host system 61 can obtain the initial depth information from the device such as a lens 60 and a sensor 59 by the default setting. For example, as shown on the right of FIG. 7, ratio 0 which is the null setting of the tunable lens 54. The user can analyze the depth information shown on the host system 61 to identify the object and send control signal based on a user input to the control unit 55. If the object is not clear, user can change the ratio to illuminating wider area, for example ratio 80.

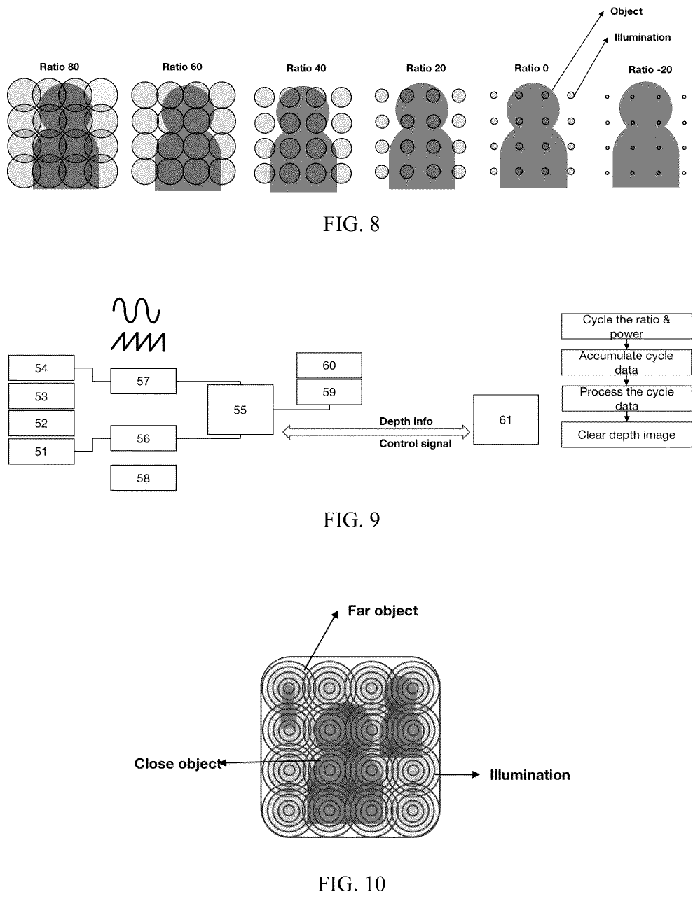

As shown in FIG. 8, when the dot light is small, it can detect an object at a longer distance, but it tends to be difficult to identify the object's details because not many light dots are hitting the object. The illumination power might change based on the ratio, so that a user can optimize the ratio and the driving power of the light source 51 to get a clear image. As shown in FIG. 8, the flood-dot ratio changes from ratio 80 to ratio −20.

FIG. 9 schematically shows a block diagram of an illumination module according to still another embodiment. In FIG. 9, the illumination module for a three-dimensional depth-sensing device comprises: a light source 51, a diffuser 53, a tunable lens 54, a lens unit 52, a first driver 56 and a second driver 57 and a power circuit 58, as explained in FIG. 5. In the solution of FIG. 9, the control unit 55 automatically sets the tunable lens in a cycle of statues based on the control signal from the host system 61.

The host system 61 can set the continuous driving/control signals as predefined free-running mode or custom mode and obtain the multiple depth data at different illumination ratio and light source power. Accumulating one cycle of the depth data will provide the variety of the depth data set for 3D image over the distance.

As shown on the right portion of FIG. 9, the host system 61 sends control signal to cycle the flood-dot ratio and corresponding power to the control unit 55 to change the illuminations. The host system 61 accumulates the cycle data for the sensed images and processes the cycle data. The host system 61 may get a clear depth image by using the processed cycle data. Because the cycle data contains more information regarding the near and remote position, the final depth image will have a better quality. As shown in FIG. 10, the 3D depth image will contain near object and far object.

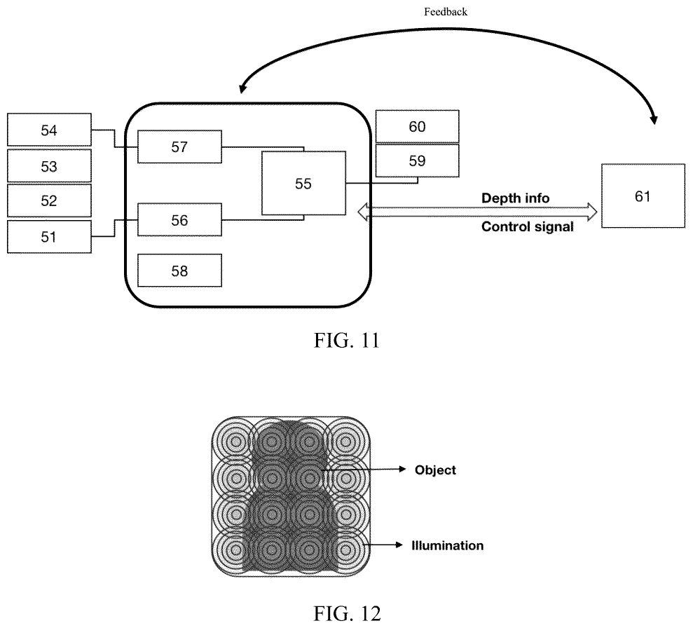

FIG. 11 schematically shows a block diagram of an illumination module according to further another embodiment. In FIG. 11, the illumination module for a three-dimensional depth-sensing device comprises: a light source 51, a diffuser 53, a tunable lens 54, a lens unit 52, a first driver 56 and a second driver 57 and a power circuit 58, as explained in FIG. 5. In the solution of FIG. 11, the host system 61 can act as a machine learning unit. The host system 61 can send control signal to the control unit 55 to drive the illumination module and can receive the depth info and the sensed image as feedback. The host system 61 determines a desirable status for the tunable lens. The feedback loop can be linear or non-linear. The control unit 55 sets the tunable lens to the desirable status determined by the machine learning unit 61. As shown in FIG. 12, a clear image of an object will be obtained through the illumination determined by the host system 61.

As described with reference to FIG. 3, a three-dimensional depth-sensing device can comprises an illumination module as described above and an imaging module, which senses three-dimensional depth information by obtaining light coming from the illumination module and reflected or diffused by an object.

Although some specific embodiments of the disclosure have been demonstrated in detail with examples, it should be understood by a person skilled in the art that the above examples are only intended to be illustrative but not to limit the scope of the disclosure.

What is claimed is:

1. An illumination module for a three-dimensional depth-sensing device, comprising:
a light source configured to emit light;
a diffuser, configured to receive the light emitted from the light source and emit diffused light;
a tunable lens, positioned after the diffuser and configured to receive the diffused light and emit tuned light, and having at least three statuses; and
a control unit, configured to set the tunable lens to one of the at least three statuses,
wherein the at least three statuses of the tunable lens correspond to at least three configurations of the tuned light between a dot light and a flood light.

2. The illumination module according to claim 1, further comprising:
a lens unit, placed between the light source and the diffuser to collimate the light from the light source.

3. The illumination module according to claim 1, wherein the control unit is configured to set the tunable lens to one of the at least three statuses based on a manual input of a user.

4. The illumination module according to claim 1, wherein the control unit is configured to automatically set the tunable lens in a cycle of statues.

5. The illumination module according to claim 1, further comprising a machine learning unit, determining a desirable status for the tunable lens,
wherein the control unit is configured to set the tunable lens to the desirable status determined by the machine learning unit.

6. The illumination module according to claim 1, wherein the tunable lens includes an electronically tunable liquid crystal lens, to be electrically controllable by applying a voltage.

7. The illumination module according to claim 1, wherein the tunable lens includes a polymer lens with the electrically controllable actuator,
wherein the electrically controllable actuator is configured to change the polymer lens to one of the at least three statuses.

8. The illumination module according to claim 7, wherein the electrically controllable actuator includes a voice coil or a piezo unit.

9. The illumination module according to claim 7, wherein the control unit is configured to set the tunable lens to one of the at least three statuses based on at least one of a current illumination ratio and depth information.

10. A three-dimensional depth-sensing device, comprising:
an illumination module according to claim 1; and
an imaging module, sensing three-dimensional depth information by obtaining light coming from the illumination module and reflected or diffused by an object.
